(19) United States
(12) Patent Application Publication
(10) Pub. No.: US 2020/0104708 A1
(43) Pub. Date: Apr. 2, 2020

(54) TRAINING APPARATUS, INFERENCE APPARATUS AND COMPUTER READABLE STORAGE MEDIUM

(71) Applicant: Preferred Networks, Inc., Tokyo (JP)

(72) Inventor: Daisuke MOTOKI, Tokyo (JP)

(21) Appl. No.: 16/585,083

(22) Filed: Sep. 27, 2019

(30) Foreign Application Priority Data
Oct. 1, 2018 (JP) 2018-186943

(51) Int. Cl. G06N 3/08; G06T 7/00; G06N 3/04

(52) U.S. Cl. CPC G06N 3/08; G06T 7/0004; G06T 2207/20021; G06T 2207/30148; G06T 2207/20081; G06N 3/04

(57) ABSTRACT

Techniques for improving simulation accuracy of a trained model are disclosed. One aspect of the present disclosure relates to a training apparatus, including: a memory storing a training model including an encoder unit having multiple convolutional layers and a decoder unit having multiple corresponding deconvolutional layers; and one or more processors that are configured to: calculate a feature indicative of a dependency of data in a predetermined direction based on a data set output from a N-th convolutional layer (N is a positive integer) in the encoder unit; and input the calculated feature to a N-th deconvolutional layer in the decoder unit.

### BACKGROUND

### 1. Technical Field

The disclosure herein relates to a training apparatus, an inference apparatus and a trained model.

### 2. Description of the Related Art

Conventionally, semiconductor manufacturers generate physical models for respective fabrication processes (for example, dry etching, deposition and so on) and perform simulation so as to seek optimal recipes, adjust process parameters and so on.

Meanwhile, since the semiconductor fabrication processes have complicated behavior and accordingly some phenomena are difficult to be modeled in the physical models, simulation accuracy of the physical models is limited. To this end, there is a recent discussion of machine learning based models being applied as alternatives of the physical models.

In order to improve the simulation accuracy of trained models, incoming higher-resolution image data must be used to train the models. Meanwhile, a memory capacity of a training apparatus is limited, and image data having a larger size must be divided into several blocks beforehand and be inputted to the training apparatus.

However, if the image data is divided into the several blocks in this manner, some influences may arise due to gaps between the blocks, which may reduce the simulation accuracy. In addition, in semiconductor fabrication processes, phenomena at each position on a wafer may correlate with those at other positions. As a result, if the image data is divided into the several blocks, the phenomena at other positions may not be reflected, which may further reduce the simulation accuracy.

### SUMMARY

The present disclosure relates to improvement of the simulation accuracy of the trained models.

One aspect of the present disclosure relates to a training apparatus, comprising: a memory storing a training model including an encoder unit having multiple convolutional layers and a decoder unit having multiple corresponding deconvolutional layers; and one or more processors that are configured to: calculate a feature indicative of a dependency of data in a predetermined direction based on a data set output from a N-th convolutional layer (N is a positive integer) in the encoder unit; and input the calculated feature to a N-th deconvolutional layer in the decoder unit.

Another aspect of the present disclosure relates to an inference apparatus, comprising: a memory storing a trained model including an encoder unit having multiple convolutional layers and a decoder unit having multiple corresponding deconvolutional layers, wherein the trained model is trained with training image data; and one or more processors that are configured to: calculate a feature indicative of a dependency of data in a predetermined direction based on a data set output from a N-th convolutional layer (N is a positive integer) in the encoder unit; and input the calculated feature to a N-th deconvolutional layer in the decoder unit.

Another aspect of the present disclosure relates to a computer-readable storage medium for storing a trained model trained by a computer with use of training image data, wherein the trained model includes an encoder unit having multiple convolutional layers and a decoder unit having multiple corresponding deconvolutional layers, and the computer is configured to: calculate a feature indicative of a dependency of data in a predetermined direction based on a data set output from a N-th convolutional layer (N is a positive integer) in the encoder unit; and input the calculated feature to a N-th deconvolutional layer in the decoder unit.

### BRIEF DESCRIPTION OF THE DRAWINGS

Other objects and further features of the present invention will be apparent from the following detailed description when read in conjunction with the accompanying drawings, in which:

FIG. 1 is a drawing for illustrating one exemplary general arrangement of a simulation system;

FIG. 2 is a drawing for illustrating one exemplary hardware arrangement of respective apparatuses in the simulation system;

FIG. 3 is a drawing for illustrating one exemplary training data;

FIG. 4 is a drawing for illustrating one exemplary functional arrangement of a training unit in a training apparatus;

FIG. 5 is a drawing for illustrating exemplary specific operations at an image division unit and an input data generation unit in the training apparatus;

FIG. 6 is a drawing for illustrating one exemplary architecture of a training model of the training unit;

FIG. 7 is a drawing for illustrating one exemplary specific operation at an autoregression module in the training model;

FIG. 8 is a flowchart for illustrating one exemplary training operation of the training apparatus;

FIG. 9 is a drawing for illustrating one exemplary functional arrangement of an execution unit in an inference apparatus;

FIG. 10 is a flowchart for illustrating one exemplary inference operation at the inference apparatus; and

FIGS. 11A to 11C are drawings for illustrating simulation results of a trained model.

### DESCRIPTION OF THE PREFERRED EMBODIMENTS

Embodiments of the present disclosure are described below with reference to the drawings. The same or like reference numerals may be attached to components having substantially the same functionalities and/or structures throughout the specification and the drawings, and descriptions thereof may not be repeated.

### First Embodiment

### <General Arrangement of Simulation System>

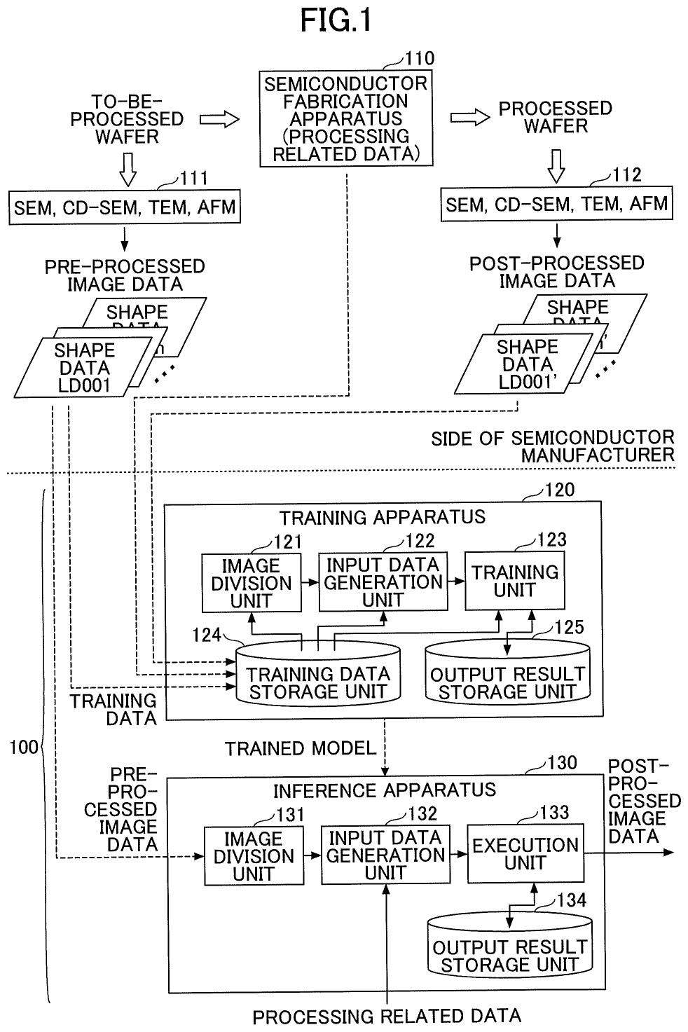

First, a general arrangement of a simulation system for performing simulation on semiconductor fabrication processes is described. FIG. 1 is a drawing for illustrating one exemplary general arrangement of the simulation system. As illustrated in FIG. 1, a simulation system 100 has a training apparatus 120 and an inference apparatus 130. In this embodiment, various data handled by the simulation system 100 are obtained from a semiconductor manufacturer or a database in the semiconductor manufacturer.

An upper side in FIG. 1 illustrates an operational flow to obtain various data at the semiconductor manufacturer. As illustrated in the upper side in FIG. 1, various parameter data (for example, one-dimensional data) is configured for a semiconductor fabrication apparatus 110. Upon to-be-processed multiple wafers (objects) being carried in, the semiconductor fabrication apparatus 110 performs operations corresponding to respective fabrication processes (for example, dry-etching and deposition) under the configured various parameter data.

Meanwhile, some of the to-be-processed multiple wafers are delivered to a measurement apparatus 111 to measure their shapes at various positions. In this manner, the measurement apparatus 111 generates “pre-processed image data” (two-dimensional image data), that is, image data obtained as a result of imaging a to-be-processed wafer before processing. Specifically, the pre-processed image data images cross-sectional shapes at respective positions on the to-be-processed wafer. Note that the measurement apparatus 111 may include a scanning electron microscope (SEM), a critical dimension-scanning electron microscope (CD-SEM), a transmission electron microscope (TEM), an atomic force microscope (AFM) or the like.

An example in FIG. 1 illustrates that the measurement apparatus 111 generates pre-processed image data such as ones having file name=“shape data LD001”, “shape data LD002”, “shape data LD003” or the like.

Meanwhile, when operations corresponding to respective fabrication processes are performed at the semiconductor fabrication apparatus 110, a processed wafer is carried out from the semiconductor fabrication apparatus 110. At this time, environment data (for example, one-dimensional data) indicative of an environment during execution of the operations corresponding to the respective fabrication processes is stored in the semiconductor fabrication apparatus 110. Similar to the various parameter data, the environment data stored in the semiconductor fabrication apparatus 110 may be arbitrary data related to the operations, which has been obtained at execution of the operations corresponding to the fabrication processes on the to-be-processed wafers. Accordingly, the various parameter data configured for the semiconductor fabrication apparatus 111 and the stored environment data may be referred to as “processing related data” hereinafter.

Some of processed wafers carried out from the semiconductor fabrication apparatus 110 are delivered to the measurement apparatus 112, which measures their shapes at various positions. In this manner, the measurement apparatus 112 generates “post-processed image data” (two-dimensional image data), that is, image data obtained as a result of imaging a processed wafer after processing. Specifically, the post-processed image data images cross-sectional shapes of the processed wafer at various positions. Note that similar to the measurement apparatus 111, the measurement apparatus 112 may include a scanning electron microscope (SEM), a critical dimension-scanning electron microscope (CD-SEM), a transmission electron microscope (TEM), an atomic force microscope (AFM) or the like.

The example in FIG. 1 illustrates that the measurement apparatus 112 generates the post-processed image data such as ones having file name=“shape data LD001′”, “shape data LD002′”, “shape data LD003′” or the like.

Various data obtained in the above manners (the pre-processed image data generated from the measurement apparatus 111, the processing related data configured or stored in the semiconductor fabrication apparatus 110 and the post-processed image data generated from the measurement apparatus 112) is collected for use as training data. In the training apparatus 120, the collected training data is stored in a training data storage unit 124.

Programs for image division, input data generation and training are installed in the training apparatus 120, and when these programs are executed, the training apparatus 120 functions as an image division unit 121, an input data generation unit 122 and a training unit 123.

The image division unit 121, which is one example of a division unit, reads the pre-processed image data from the training data storage unit 124 and divides it into multiple blocks having an image size corresponding to a memory capacity of the training apparatus 120. The image division unit 121 provides the divided blocks to the image data generation unit 122 sequentially.

The input data generation unit 122, which is one example of a generation unit, reads the processing related from the training data storage unit 124 and in response to the blocks provided from the image division unit 121, arranges the processing related data in a predetermined format suitable for inputting to a training model by the training unit 123.

Specifically, the input data generation unit 122 arranges the respective processing related data in a two-dimensional array format corresponding to a vertical size and a horizontal size of the blocks. In general, the training model in the training unit 123 uses data having an image data format as inputs. As a result, data that is not constructed as any image data format must be arranged in an image data format, and the input data generation unit 122 arranges the processing related data in the image data format (two-dimensional array format).

Note that the processing related data may be arranged at the time of storage in the training data storage unit 124. In this case, the input data generation unit 122 would read out data arranged in a two-dimensional array format.

The input data generation unit 122 concatenates the data arranged in the two-dimensional array format with provided respective blocks to generate concatenated data and inputs the concatenated data to training unit 123 sequentially.

The training unit 123 inputs the concatenated data provided from the input data generation unit 122 to the training model sequentially and stores output, results from the training model in an output result storage unit 125. Also, the training unit 123 integrates the output results stored in the output result storage unit 125 and compares the integrated output results with post-processed image data fetched from the training data storage unit 124.

In this manner, the training unit 123 updates model parameters in accordance with a machine learning procedure such that the integrated output results can approach the post-processed image data to generate a trained model. The trained model generated at the training unit 123 is provided and installed to the inference apparatus 130.

Programs for image division, input data generation and execution are installed in the inference apparatus 130, and when the programs are executed, the inference apparatus 130 functions as an image division unit 131, an input data generation unit 132 and an execution unit 133.

The image division unit 131, which is one example of a division unit, divides arbitrary pre-processed image data (for example, pre-processed image data generated at the measurement apparatus 111) into multiple blocks having an image size corresponding to a memory capacity of the inference apparatus 130. The image division unit 131 provides the divided blocks to the input data generation unit 132 sequentially.

The input data generation unit 132, which is one example of a generation unit, obtains processing related data input to the inference apparatus 130 and in response to the blocks provided from the image division unit 131, arranges the processing related data in a predetermined format suitable for inputting to a trained model by the execution unit 133. Specifically, the input data generation unit 132 arranges the respective processing related data input to the inference apparatus 130 in a two-dimensional array format corresponding to a vertical size and a horizontal size of the blocks.

The processing related data input to the inference apparatus 130 may refer to: data corresponding to various parameter data configured for the semiconductor fabrication apparatus 110; and/or data corresponding to environment data indicative of an environment during execution of operations corresponding to individual fabrication processes performed by the semiconductor fabrication apparatus 110.

Also, the input data generation unit 132 concatenates data arranged in a two-dimensional array format with respective blocks and provides concatenated data to the execution unit 133 sequentially.

The execution unit 133 inputs the concatenated data provided from the input data generation unit 132 to the trained model sequentially and executes the trained model to generate post-processed image data (simulation results).

For example, a user of the inference apparatus 130 can compare the post-processed image data provided from the trained model through execution of the execution unit 133 with the corresponding post-processed image data generated at the measurement apparatus 112 to validate the trained model.

Specifically, the user of the inference apparatus 130 compares the post-processed image data, which is provided from the execution unit 133 in response to the pre-processed image data being input to the image division unit 131 and the processing related data configured and stored in the semiconductor fabrication apparatus 110 being input to the input data generation unit 132, to the post-processed image data, which is obtained through processing a to-be-processed wafer at the semiconductor fabrication apparatus 110 and measurement of the processed wafer at the measurement apparatus 112. In this manner, the user of the inference apparatus 130 can calculate simulation errors of the trained model and validate simulation accuracy.

Note that after completing the validation of the simulation accuracy, arbitrary pre-processed image data and arbitrary processing related data are provided to the inference apparatus 130 for various simulations. In this manner, the user of the inference apparatus 130 can determine optimal recipes and parameter data in the semiconductor fabrication processes and seek an optimal hardware implementation.

### <Hardware Arrangement of Respective Apparatuses Composing Simulation System>

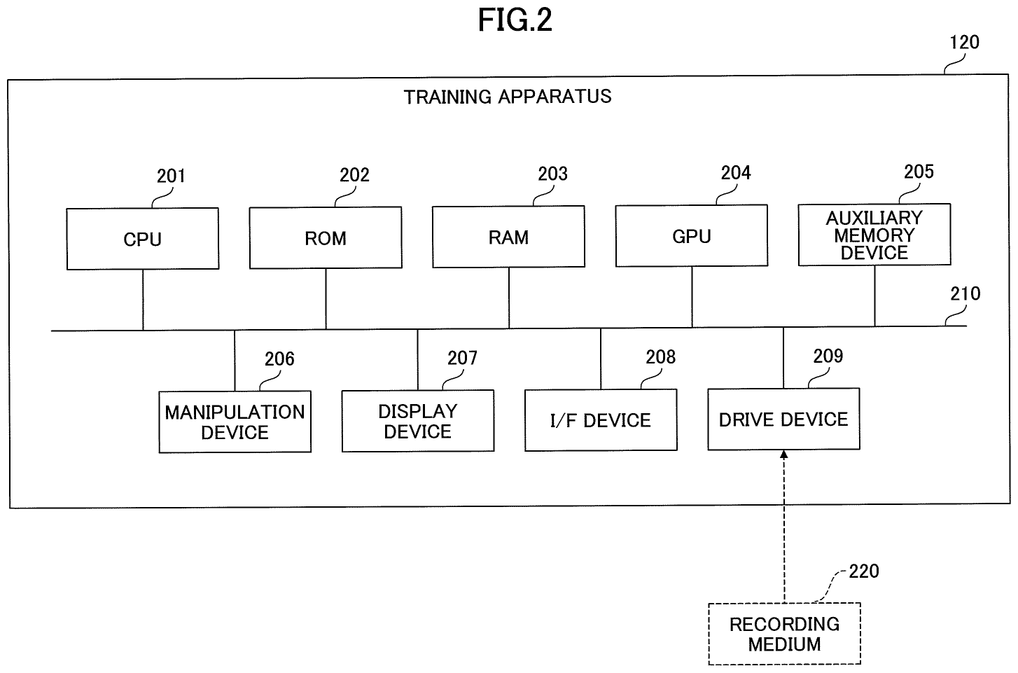

Next, a hardware arrangement of the respective apparatuses (training apparatus 120 and the inference apparatus 130) composing the simulation system 100 is described with reference to FIG. 2. FIG. 2 is a drawing for illustrating one exemplary hardware arrangement of the respective apparatuses composing the simulation system 100.

Note that since the respective hardware arrangements of the training apparatus 120 and the inference apparatus 130 are almost the same, the hardware arrangement of the training apparatus 120 is described herein.

FIG. 2 is a drawing for illustrating one exemplary hardware arrangement of the training apparatus 120. As illustrated in FIG. 2, the training apparatus 120 has a CPU (Central Processing Unit) 201 and a ROM (Read Only Memory) 202. Also, the training apparatus 120 has a RAM (Random Access Memory) 203 and a GPU (Graphics Processing Unit) 204. Processors (processing circuits, processing circuitries or the like) such as the CPU 201 and the GPU 204 and memories such as the ROM 202 and the RAM 203 form a so-called computer.

Also, the training apparatus 120 has an auxiliary memory device 205, a manipulation device 206, a display device 207, an I/F (interface) device 208 and a drive device 209. The respective hardware items in the training apparatus 120 are interconnected via a bus 210.

The CPU 201 is an arithmetic device for performing various programs or instructions (for example, an image division program, an input data generation program, a training program and so on) installed in the auxiliary memory device 205.

The ROM 202 is a non-volatile memory and serves as a main memory device. The ROM 202 stores various programs, data and so on needed by the CPU 201 to execute various programs and/or instructions installed in the auxiliary memory device 205. Specifically, the ROM 202 stores boot programs and others such as a BIOS (Basic Input/Output System) or an EFI (Extensible Firmware Interface).

The RAM 203 is a volatile memory such as a DRAM (Dynamic Random Access Memory) or a SRAM (Static Random Access Memory) and serves as a main memory device. The RAM 203 provides a working space expanded by the CPU 201 executing various programs and/or instructions installed in the auxiliary memory device 205.

The GPU 204 is an arithmetic device for image processing and performs fast computation with parallel processing on various image data in execution of an image division program, an input data generation program and a training program at the CPU 201.

The GPU 204 incorporates an internal memory (GPU memory) to store information needed to perform parallel operations on various image data temporarily.

The auxiliary memory device 205 stores various program, various image data manipulated by the GPU 204 for image processing in the course of execution of various programs at the CPU 201, or the like. For example, the training data storage unit 124 and the output result storage unit 125 are implemented in the auxiliary memory device 205.

The manipulation device 206 is an input device used for an administrator of the training apparatus 120 to input various instructions to the training apparatus 120. The display device 207 is a display device for displaying an internal state of the training apparatus 120. The I/F device 208 is a connection device to connect to other devices for communication.

The drive device 209 is a device for setting the recording medium 220. The recording medium 220 herein includes a medium for recording information optically, electrically or magnetically, such as a CD-ROM, a flexible disk or a magneto-optical disk. Also, the recording medium 220 may include a semiconductor memory or any other computer-readable storage medium for storing information electrically such as a ROM or a flash memory.

For example, various programs and/or instructions are installed in the auxiliary memory device 205 by setting the distributed recording medium 220 in the drive device 209 and reading out the various programs and/or instructions recorded in the recording medium 220 via the drive device 209. Alternatively, the various programs and/or instructions may be installed in the auxiliary memory device 205 through downloading via not-illustrated networks.

### <Description of Training Data>

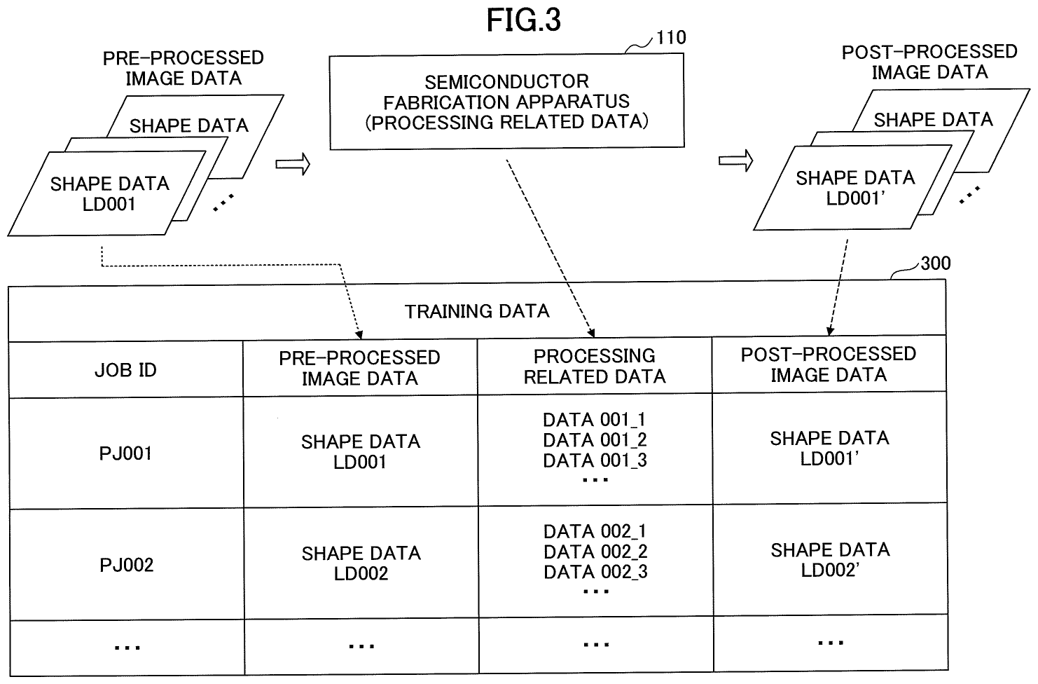

Next, training data stored in the training data storage unit 124 is described. FIG. 3 is a drawing for illustrating one exemplary training data. As illustrated in FIG. 3, training data 300 includes information items “job ID”, “pre-processed image data”, “processing related data” and “post-processed image data”.

The “job ID” has an identifier for identifying a job performed by the semiconductor fabrication apparatus 110. In the example in FIG. 3, “PJ001” and “PJ002” are stored as “job ID”.

The “pre-processed image data” stores a file name of arbitrary pre-processed image data (for example, pre-processed image data generated at the measurement apparatus 111). In the example in FIG. 3, the job ID=“PJ001” means that the measurement apparatus 111 has generated pre-processed image data corresponding to file name=“shape data LD001” from one to-be-processed wafer in a lot (a set of wafers) for that job.

Also, in the example in FIG. 3, job ID=“PJ002” means that the measurement apparatus 111 has generated pre-processed image data corresponding to file name=“shape data LD002” from one to-be-processed wafer in a lot (a set of wafers) for that job.

The “processing related data” accommodates various parameter data, which has been configured for the semiconductor fabrication apparatus 110 to process the to-be-processed wafers, to indicate a predetermined processing condition. Alternatively, the “processing related data” accommodates environment data indicative of an environment during processing the to-be-processed wafers at the semiconductor fabrication apparatus 110. In the example in FIG. 3, it is illustrated that when the semiconductor fabrication apparatus 110 performs an operation corresponding to job ID=“PJ001”, “data 001_1”, “data001_2”, “data001_3”, . . . are configured or stored.

Note that “data 001_1”, “data001_2”, “data001_3”, . . . may include data configured as setting values for the semiconductor fabrication apparatus 110 such as Pressure (pressure within a chamber), Power (power of a high-frequency power supply), Gas (gas flow rate) and Temperature (temperature within a chamber or surface temperature of a wafer); data configured as target values for the semiconductor fabrication apparatus 110 such as CD (limit size), Depth (depth), Taper (taper angle), Tilting (tilt angle) and Bowing (bowing); and information on a hardware implementation of the semiconductor fabrication apparatus 110 or others.

Alternatively, “data 001_1”, “data001_2”, “data001_3”, . . . may include data stored in the semiconductor fabrication apparatus 110 during processing such as Vpp (potential difference), Vdc (direct self-bias voltage), OES (emission intensity with emission spectroscopy), Reflect (power of a reflected wave) and Top DCS current (detection value with a Doppler velocimeter); and data measured and stored during processing of the semiconductor fabrication apparatus 110 such as Plasma density (plasma density), Ion energy (ion energy) and Ion flux (ion flux) or others.

The “post-processed image data” has a file name of post-processed image data generated at the measurement apparatus 112. In the example in FIG. 3, it is illustrated that if job ID=“PJ001”, the measurement apparatus 112 has generated post-processed image data corresponding to file name=“shape data LD001′”.

Also, in the example in FIG. 3, it is illustrated that if job ID=“PJ002”, the measurement apparatus 112 has generated post-processed image data corresponding to file name=“shape data LD002′”.

### <Detail of Functional Arrangement of Training Apparatus>

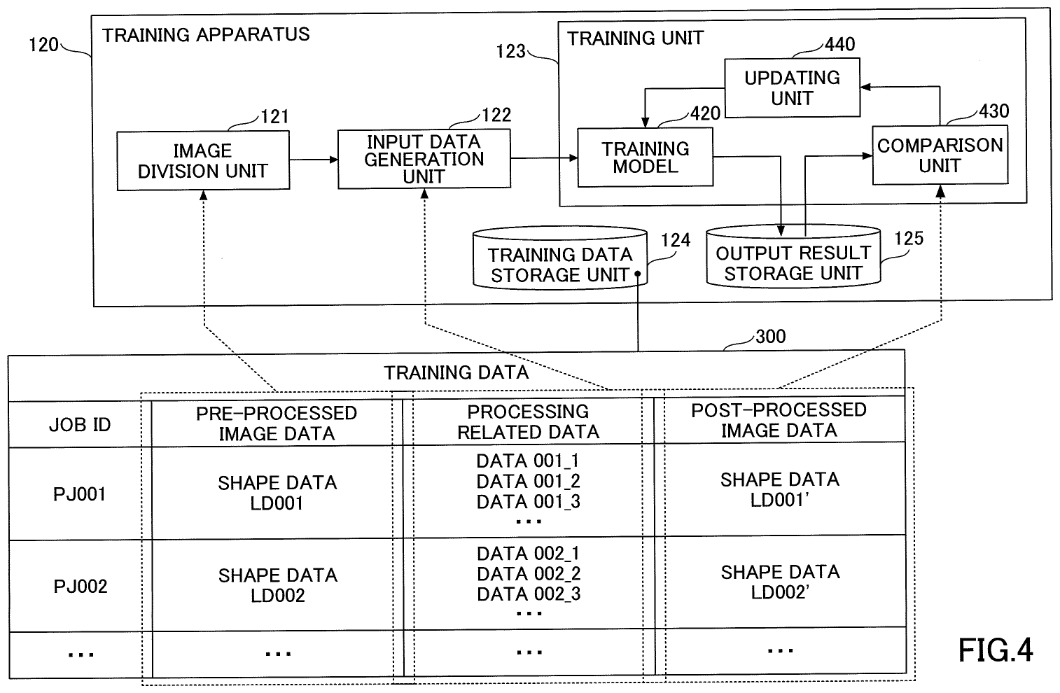

Next, details of a functional arrangement of the training unit 123 in the training apparatus 120 are described. FIG. 4 is a drawing for illustrating one exemplary functional arrangement of the training unit 123 in the training apparatus 120. As stated above, the training apparatus 120 has the image division unit 121, the input data generation unit 122 and the training unit 123. Then, as illustrated in FIG. 4, the training unit 123 further has a training model 420, a comparison unit 430 and an updating unit 440.

As stated above, the pre-processed image data is fetched by the image division unit 121 from training data 300 stored in the training data storage unit 124 and is divided into multiple blocks, which are then provided to the input data generation unit 122.

Also, the processing related data is fetched by the input data generation unit 122 from the training data 300 stored in the training data storage unit 124 and is arranged in a two-dimensional array format. Then, the arranged processing related data is concatenated with respective blocks provided from the image division unit 121. In addition, concatenated data generated by concatenating with the blocks is sequentially input by the input data generation unit 122 to the training model 420.

Upon the concatenated data being input sequentially, some operations are performed in the training model 420, and output results are stored in the output result storage unit 125 sequentially.

The comparison unit 430 fetches respective output results corresponding to the multiple blocks from the output result storage unit 125 to integrate the output results. Also, the comparison unit 430 fetches the post-processed image data from the training data storage unit 124, calculates difference information based on comparison to respective integrated output results and provides the difference information to the updating unit 440.

The updating unit 440 updates model parameters for the training model 420 based on the difference information provided from the comparison unit 430. Note that the difference information used to update the model parameters may be a square error or an absolute error.

In this manner, according to the training unit 123, a trained model corresponding to the training data 300 can be generated.

### <Description of Operations of Respective Units in Training Apparatus>

Next, operations of respective units (the image division unit 121, the input data generation unit 122 and the training unit 123) in the training apparatus 120 are described in detail.

### (1) Exemplary Operations of the Image Division Unit and the Input Data Generation Unit

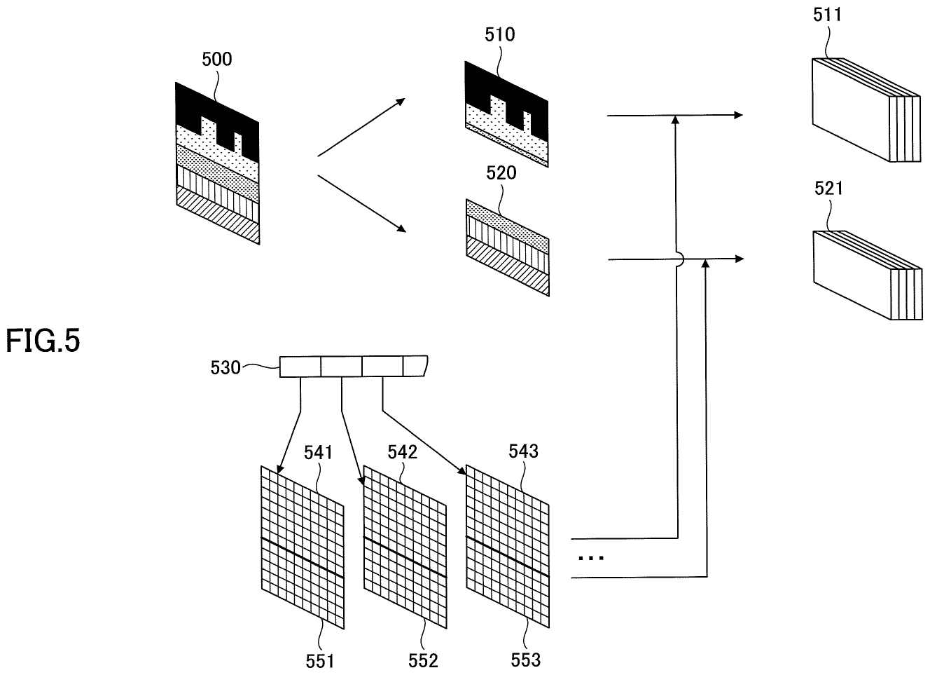

First, exemplary operations of the image division unit 121 and the input data generation unit 122 are described. FIG. 5 is a drawing for illustrating exemplary operations of the image division unit 121 and the input data generation unit 122 in the training apparatus 120.

As illustrated in FIG. 5, upon receiving incoming pre-processed image data 500, the image division unit 121 divides the pre-processed image data 500 corresponding to a memory capacity of a GPU memory in the training apparatus 120. In the example in FIG. 5, the image division unit 121 bisects the pre-processed image data 500 at a predetermined vertical position to generate two blocks (block 510 and block 520).

Although the case of the pre-processed image data 500 being divided into the two blocks is illustrated in the example in FIG. 5, the divisional number is not limited to the two, and the pre-processed image data 500 may be divided into three or more blocks. Also, the case of the pre-processed image data 500 being divided into the upper block and the lower block with respect to the vertical direction is illustrated in the example in FIG. 5, but the divisional direction is not limited to it, and the pre-processed image data 500 may be divided into right and left blocks with respect to the horizontal direction. Namely, the division of the pre-processed image data 500 in a predetermined direction means that the pre-processed image data 500 is divided into several blocks with one or more divisional lines approximately orthogonal to a predetermined direction.

The image division unit 121 provides the blocks 510 and 520 obtained as a result of the division of the pre-processed image data 500 to the input data generation unit 122 sequentially.

Upon receiving the block 510, as illustrated in FIG. 5, the input data generation unit 122 arranges the processing related data 530 into two-dimensional arrays (two-dimensional array data 541, 542, 543, . . . ) corresponding to vertical and horizontal sizes of the block 510. Also, as illustrated in FIG. 5, the input data generation unit 122 concatenates the two-dimensional array data 541, 542, 543, . . . with the block 510 as a new channel to generate concatenated data 511.

Similarly, upon receiving the block 520, the input data generation unit 122 arranges the processing related data 530 into two-dimensional arrays (two-dimensional array data 551, 552, 553, . . . ) corresponding to vertical and horizontal sizes of the block 520. Also, the input data generation unit 122 concatenates the two-dimensional array data 551, 552, 553, . . . with the block 520 as a new channel to generate concatenated data 521.

### (2) Exemplary Operations of the Training Unit

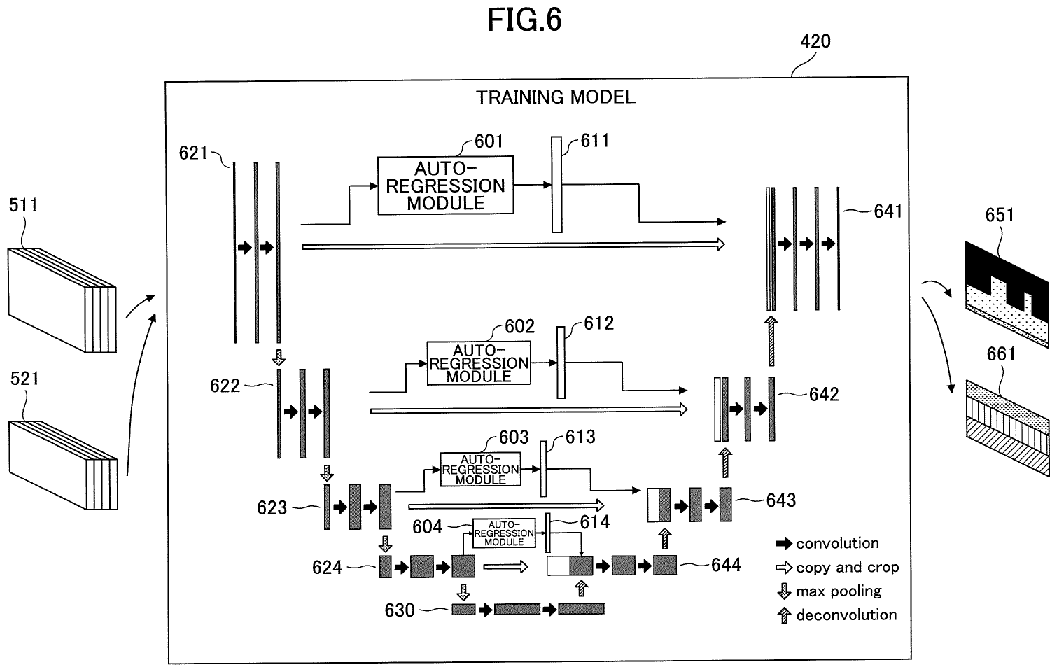

Next, exemplary operations of the training model 420 in the training unit 123 are described with reference to FIG. 6. FIG. 6 is a drawing for illustrating an exemplary architecture of the training model 420 in the training unit 123. As illustrated in FIG. 6, in this embodiment, a machine learning model based on a U-shaped convolutional neural network (CNN), a so-called UNET, is used as the training model 420.

Specifically, the training model 420 has an encoder unit including multiple layers 621-624 and 630 each having a convolutional layer and a decoder unit including multiple layers 641-644 each having the corresponding deconvolutional layer.

In general, the UNET receives incoming image data and outputs image data. Accordingly, if the UNET is used as the training model, the pre-processed image data and the post-processed image data for semiconductor fabrication processes can be handled as input and output data. Specifically, the UNET can receive incoming concatenated data 511 and 512 and output respective output results 651 and 661.

In other words, in the UNET, incoming data having an image data format is used. To this end, data that is not in any image data format need to be arranged into an image data format. In the above-stated input data generation unit 122, the processing related data as one-dimensional data is arranged into two-dimensional array data to be consistent to the image data format input to the UNET.

In one embodiment, as illustrated in FIG. 6, the training model 420 of the present embodiment further includes an autoregression module besides the general UNET architecture. Specifically, the autoregression modules 601 to 604 are provided between the layers 621 to 624 in the encoder unit and the layers 641 to 644 in the decoder unit, respectively.

In this embodiment, the autoregression modules 601 to 604 serve as a calculation unit and an input unit. Specifically, the autoregression modules 601 to 604 calculate features 611 to 614, which are indicative of dependences among data in a predetermined axial direction, from data sets outputted from the layers 621 to 624 in the encoder unit. Also, the autoregression modules 601 to 604 provide the calculated features 611 to 614 to the layers 641 to 644 in the decoder unit, respectively.

The predetermined axial direction herein represents a divisional direction of the image division unit 121. As stated above, the image division unit 121 divides the pre-processed image data 500 at a predetermined vertical position. As a result, the predetermined axial direction of the present embodiment represents the vertical direction.

Although the encoder unit and the decoder unit of the training model 420 having the corresponding four layers are illustrated in FIG. 6, the number of the corresponding layers in the encoder unit and the decoder unit is not limited to the four. In the training model 420, the autoregression modules are provided corresponding to the number of the corresponding layers in the encoder unit and the decoder unit.

### (3) Exemplary Operation of Autoregression Module in Training Model

Next, exemplary operations of the autoregression modules 601 to 604 in the training model 420 are described. Each of the autoregression modules 601 to 604 performs similar operations, and exemplary operations of the autoregression module 601 are illustratively described herein.

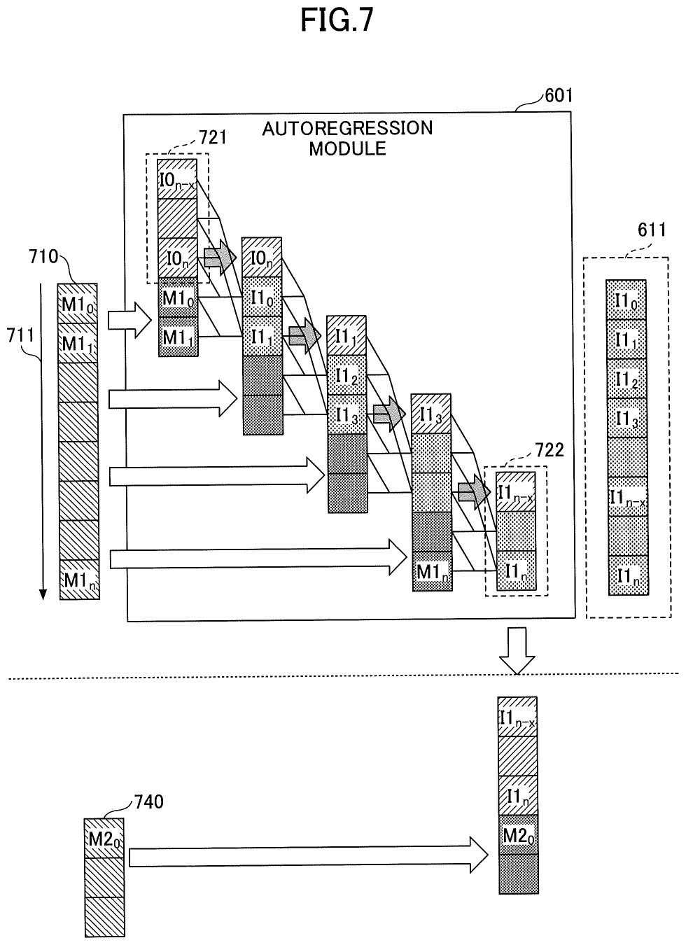

FIG. 7 is a drawing for illustrating exemplary operations of the autoregression module in the training model. For example, if first concatenated data in concatenated data generated at the input data generation unit 122 is input to the training model 420, the data set 710 is output from the layer 621 in the encoder unit.

Note that although the data set outputted from the layer 621 in the encoder unit includes multiple columns, only one column of the data set is illustrated in FIG. 7 as the m-th data set 710 (m is a positive integer, and m=1 in this example) for ease in description. Also, in the example in FIG. 7, it is illustrated that n data pieces (M1₀ to M1ₙ) are included in the first data set 710 along the predetermined axial direction 711.

Here, when the first data set 710 is output, the 0-th concatenated data has been already processed, and the data set (the (m−1)-th data set (the 0-th data set in this example)) has been output from the layer 621 in the encoder unit. Accordingly, calculation of a predicted value by the autoregression model has been finished for the 0-th data set at the autoregression module 601.

In FIG. 7, a dotted line 721 indicates predicted values (predicted values of I0ₙ₋ₓ to I0ₙ) of the autoregression model calculated for (x+1) data pieces in the 0-th data set.

Under this presumption, the autoregression module 601 calculates the predicted value (I1₀) of the autoregression model corresponding to the 0-th data (M1₀ in the first data set 710 from:

a sum of a product of a weight coefficient and the (n−2)-th predicted value (I0ₙ₋₂) in the 0-th data set and a product of a weight coefficient and the (n−1)-th predicted value (I0ₙ₋₁); and

a sum of a product of a weight coefficient and the n-th predicted value (I0ₙ) in the 0-th data set and a product of a weight coefficient and the 0-th data (M1₀) in the first data set 710.

Specifically, the autoregression module 601 calculates the predicted value (I1₀) with the formula,

$$I {1}_{0} = {w}_{05} \times ( {w}_{01} \times I {0}_{n - 2} + {w}_{02} \times I {0}_{n - 1} + {C}_{01} ) + {w}_{06} \times ( {w}_{03} \times I {0}_{n} + {w}_{04} \times M {1}_{0} + {C}_{02} ) + {C}_{03} ,$$

where w₀₁ to w₀₆ are weight coefficients, and C₀₁ to C₀₃ are biases. These are trained (for example, they are updated with gradient method).

Also, the autoregression module 601 calculates the predicted value (I1₁) of the autoregression model corresponding to the first data (M1₁) in the first data set 710 from:

a sum of a product of a weight coefficient and the (n−1)-th predicted value (I0ₙ₋₁) in the 0-th data set and a product of a weight coefficient and the n-th predicted value (I0ₙ); and

a sum of a product of a weight coefficient and the 0-th data (M1₀) in the first data set and a product of a weight coefficient and the first data (M1₁) in the first data set 710. Specifically, the autoregression module 601 calculates the predicted value (I1₁) with the formula,

$$I {1}_{1} = {w}_{15} \times ( {w}_{11} \times I {0}_{n - 1} + {w}_{12} \times I {0}_{n} + {C}_{11} ) + {w}_{16} \times ( {w}_{13} \times M {1}_{0} + {w}_{14} \times M {1}_{1} + {C}_{12} ) + {C}_{13} ,$$

where w₁₁ to w₁₆ are weight coefficients, and C₁₁ to C₁₃ are biases. These are trained (for example, they are updated with gradient method).

Similarly, the autoregression module 601 calculates the predicted value (I1₂) of the autoregression model corresponding to the second data (M1₂) in the first data set 710 from:

a sum of a product of a weight coefficient and the n-th predicted value (I0ₙ) in the 0-th data set and a product of a weight coefficient and the 0-th data (M1₀) in the first data set; and

a sum of a product of a weight coefficient and the first data (M1₁) in the first data set and a product of a weight coefficient and the second data (M1₂) in the first data set 710. Specifically, the autoregression module 601 calculates the predicted value (I1₂) with the formula,

$$I {1}_{2} = {w}_{25} \times ( {w}_{21} \times I {0}_{n} + {w}_{22} \times M {1}_{0} + {C}_{21} ) + {w}_{26} \times ( {w}_{23} \times M {1}_{1} + {w}_{24} \times M {1}_{2} + {C}_{22} ) + {C}_{23} ,$$

where w₂₁ to w₂₆ are weight coefficients, and C₂₁ to C₂₃ are biases. These are trained (for example, they are updated with gradient method).

Also, the autoregression module 601 calculates the predicted value (I1₃) of the autoregression model corresponding to the third data (M1₃) in the first data set 710 from:

a sum of a product of a weight coefficient and the 0-th data (M1₀) in the first data set and a product of a weight coefficient and the first data (M1₁) in the first data set; and

a sum of a product of a weight coefficient and the second data (M1₂) in the first data set and a product of a weight coefficient and the third data (M1₃) in the first data set 710. Specifically, the autoregression module 601 calculates the predicted value (I1₃) with the formula,

$$I {1}_{3} = {w}_{35} \times ( {w}_{31} \times M {1}_{0} + {w}_{32} \times M {1}_{1} + {C}_{31} ) + {w}_{36} \times ( {w}_{33} \times M {1}_{2} + {w}_{34} \times M {1}_{3} + {C}_{32} ) + {C}_{33} ,$$

where w₃₁ to w₃₆ are weight coefficients, and C₃₁ to C₃₃ are biases. These are trained (for example, they are updated with gradient method).

In this manner, the autoregression module 601 calculates a first set of predicted values (I1₀ to I1ₙ) corresponding to the first data set 710 and provides the calculated set of predicted values as the feature 611 indicative of a dependency of the first data set 710 in the predetermined axial direction 711.

In other words, the predicted value (Imₙ) for n data pieces in the m-th data set can be generalized as:

ti Imₙ=F(Mmₙ, . . . , Mm₀, Im−1ₙ, . . . , Im−1ₙ₋ₓ).
However, the above-stated specific calculation of the predicted values (I1₁, I1₂, I1₃, . . . ) is merely exemplary, and the predicted values may be calculated in a different calculation manner.

For example, if the training model 420 is for simulation on etching of the semiconductor fabrication apparatus 110, the feature 611 may represent movement of plasmas in the predetermined axial direction 711. In other words, according to the training model 420, the feature indicative of the movement of plasmas calculated at the encoder unit can be reflected to the decoder unit.

Note that as illustrated in FIG. 7, the (n−x)-th predicted value to the n-th predicted value (dotted line 722) in the first data set 710 are used to calculate the 0-th predicted value and the first predicted value of the (m+1)-th data set 740 (the second data set in this example). In other words, according to the autoregression module 601, the feature calculated for the first data set 710 can be provided to the second data set 740 in the predetermined axial direction 711.

As a result, in the training model 420, the operations can be performed without causing an effect from division into multiple blocks (without causing an effect from gaps of the concatenated data and with reflection of phenomena in other concatenated data).

In addition, etching has a property of the degree of etching being determined dependently upon an amount of plasmas transported in the vertical direction. As a result, a spatial structure of the upstream side may strongly influence the downstream side of the predetermined axial direction 711, which may correlate to phenomena at other positions. In a training model (UNET) based on a general type of convolutional neural network without the autoregression module 601, however, it is difficult to reflect the influence of the spatial structure in the upstream side into the downstream side.

In the training model 420 with the autoregression modules, on the other hand, the influence of the spatial structure in the upstream side can be reflected into the downstream side. In other words, phenomena at other positions in the same concatenated data can be reflected. In this manner, regardless of whether division into multiple blocks is performed, the training model 420 with the autoregression modules is advantageous even in the case where the concatenated data is long in the predetermined axial direction 711.

### <Flow of Training Operations of Training Apparatus>

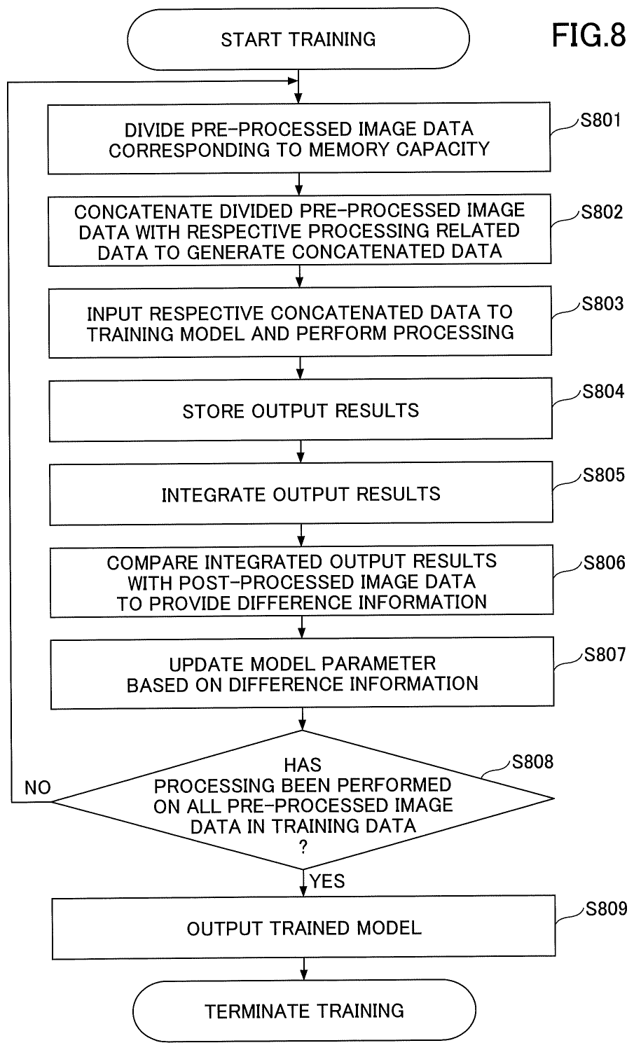

Next, training operations of the training apparatus 120 are described. FIG. 8 is a flowchart for illustrating training operations of the training apparatus 120. Upon receiving an instruction to train the training model 420 with the training data 300 stored in the training data storage unit 124, the training apparatus 120 performs the flowchart illustrated in FIG. 8.

At step S801, the image division unit 121 reads pre-processed image data from the training data storage unit 124 and divides the pre-processed image data into multiple blocks corresponding to a memory capacity of a GPU memory in the training apparatus 120.

At step S802, the input data generation unit 122 reads processing related data corresponding to the pre-processed image data fetched from the image division unit 121 from the training data storage unit 124 and arranges the processing related data in predetermined formats corresponding to the respective blocks. Also, the input data generation unit 122 concatenates the arranged processing related data with the respective blocks to generate respective concatenated data.

At step S803, the training unit 123 inputs the respective concatenated data to the training model 420 sequentially and causes the training model 420 to execute operations.

At step S804, the training unit 123 stores respective output results output from the training model 420 in the output result storage unit 125 sequentially.

At step S805, the comparison unit 430 integrates the respective output results stored in the output result storage unit 125.

At step S806, the comparison unit 430 reads post-processed image data corresponding to the pre-processed image data fetched by the image division unit 121 from the training data storage unit 124 and compares the fetched post-processed image data with the integrated respective output results to calculate difference information. Also, the comparison unit 430 provides the calculated difference information to the updating unit 440.

At step S807, the updating unit 440 updates model parameters of the training model 420 based on the difference information provided from the comparison unit 430.

At step S808, the image division unit 121 uses all the pre-processed image data in the training data storage unit 124 to determine whether the training has been performed. If it is determined at step S808 that some of the pre-processed image data have not been used for the training yet (S808: NO), the flow returns step S801.

On the other hand, if it is determined at step S808 that all the pre-processed image data have been used for the training (S808: YES), the flow proceeds to step S809.

At step S809, the training unit 123 outputs the finally obtained training model as a trained model and terminates the training operations.

### <Detail of Functional Arrangement of Inference Apparatus>

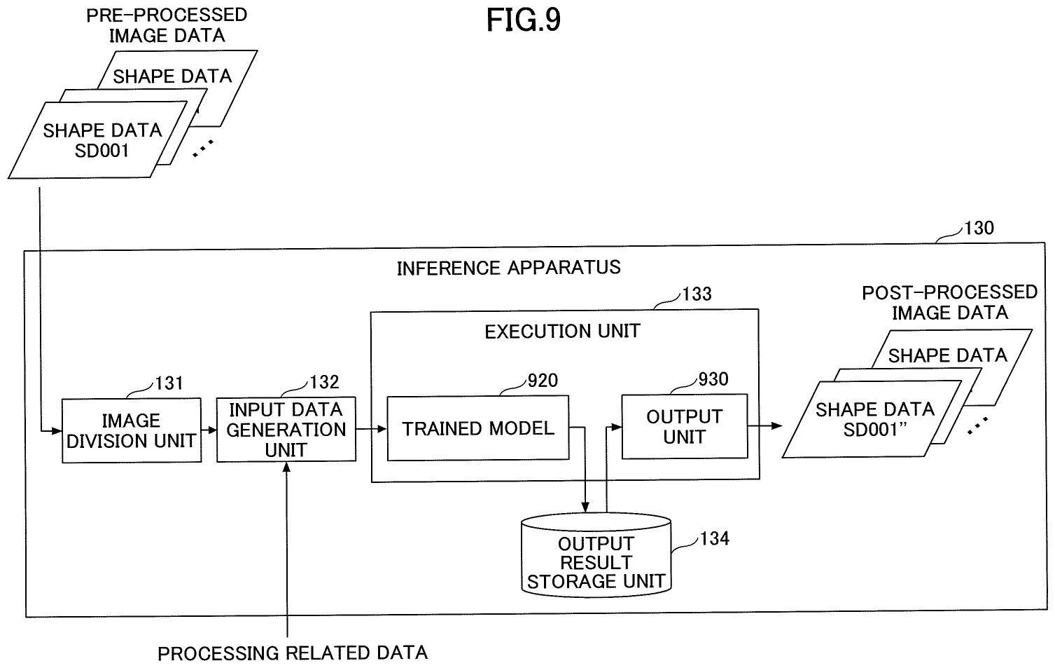

Next, a functional arrangement of the execution unit 133 in the inference apparatus 130 is described in detail. FIG. 9 is a drawing for illustrating one exemplary functional arrangement of the execution unit 133 in the inference apparatus 130 according to the first embodiment. As stated above, the inference apparatus 130 has the image division unit 131, the input data generation unit 132 and the execution unit 133. Also, as illustrated in FIG. 9, the execution unit 133 further includes a trained model 920 and an output unit 930.

Upon obtaining pre-processed image data (for example, pre-processed image data that has not been used for the training) generated at the measurement apparatus 111 and receiving incoming processing related data to the inference apparatus 130, the image division unit 131 divides the pre-processed image data into multiple blocks. Also, the input data generation unit 132 arranges the processing related data in a two-dimensional array format corresponding to the respective blocks and then concatenates the processing related data to the respective blocks to generate respective concatenated data.

In the example in FIG. 9, file name=“shape data SD001”, “shape data SD002”, . . . are obtained as the pre-processed image data generated at the measurement apparatus 111.

Upon receiving the concatenated data from the input data generation unit 132 sequentially, the trained model 920 performs simulation for the respective concatenated data and stores respective output results in the output result storage unit 134 sequentially.

The output unit 930 integrates the respective output results stored in the output result storage unit 134 to generate and output post-processed image data (for example, file name=“shape data SD001′′”, “shape data SD002′′”, . . . ).

### <Inference Operations of Inference Apparatus>

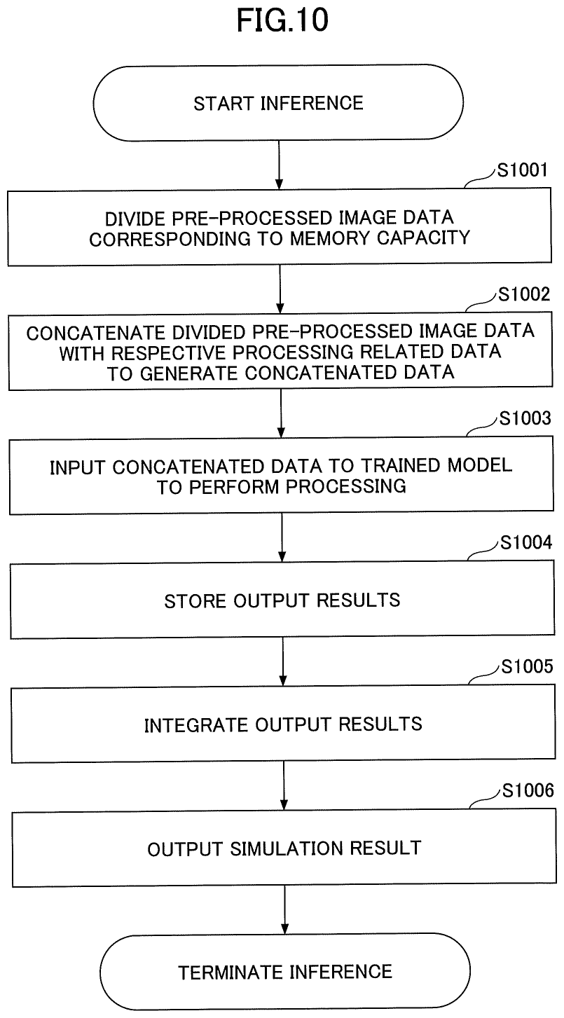

Next, inference operations of the inference apparatus 130 are described. FIG. 10 is a flowchart for illustrating inference operations of the inference apparatus 130. For example, upon receiving an instruction for simulation for pre-processed image data generated at the measurement apparatus 111, the inference apparatus 130 performs the flowchart as illustrated in FIG. 10.

At step S1001, the image division unit 131 divides the pre-processed image data into multiple blocks corresponding to a memory capacity of a GPU memory in the inference apparatus 130.

At step S1002, the input data generation unit 132 arranges processing related data input to the inference apparatus 130 in a predetermined format corresponding to the respective blocks. Also, the input data generation unit 132 concatenates the processing related data arranged in the predetermined format with the respective blocks to generate concatenated data.

At step S1003, the execution unit 133 inputs the respective concatenated data to the trained model 920 sequentially and causes the trained model 920 to execute operations.

At step S1004, the execution unit 133 stores output results output from the trained model 920 in the output result storage unit 134 sequentially.

At step S1005, the output unit 930 integrates the respective output results stored in the output result storage unit 134 to generate post-processed image data.

At step S1006, the output unit 930 provides the generated post-processed image data as simulation results.

### <Simulation Results of Trained Model>

Next, simulation results of the trained model 920 are described. Here, simulation results for the trained model 920 with the autoregression module are compared to simulation results for a trained model without the autoregression module.

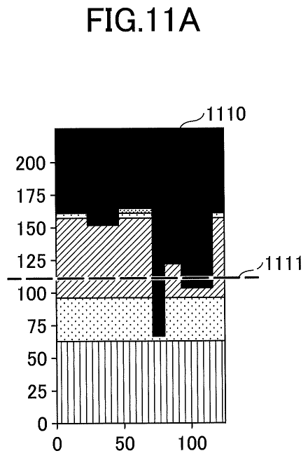

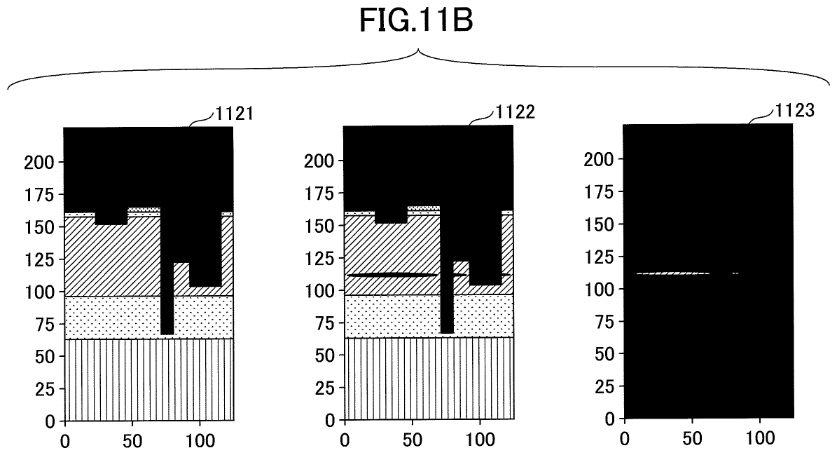

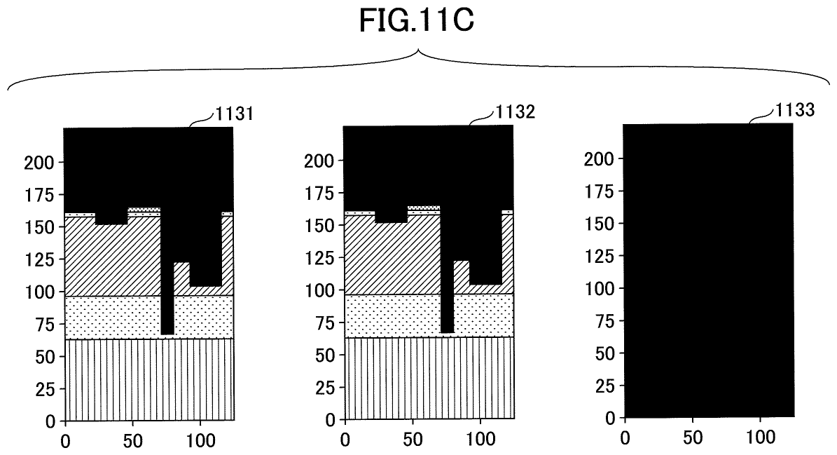

FIG. 11 is a drawing for illustrating simulation results for the trained models. FIG. 11A illustrates one exemplary pre-processed image data. As illustrated in FIG. 11A, the pre-processed image data 1110 is divided by the image division unit 131 at a position illustrated with a divisional line 1111.

FIG. 11B illustrates simulation using the trained model without the autoregression module. In FIG. 11B, the illustrated post-processed image data 1121 correspond to a simulation result for the case where the pre-processed image data 1110 is input without being divided. Meanwhile, in FIG. 11B, the illustrated post-processed image data 1122 correspond to a simulation result for the case where the incoming pre-processed image data 1110 is divided into two blocks at the divisional line 1111.

Also, in FIG. 11B, a difference image 1123 is an image indicative of a difference between the post-processed image data 1121 and the post-processed image data 1122. As illustrated in the difference image 1123, for the trained model without the autoregression module, a difference arises at the position of the divisional line 1111. In other words, according to the trained model without the autoregression module, some influence arises due to a gap resulting from division of the pre-processed image data.

On the other hand, FIG. 11C illustrates simulation using the trained model 920 with the autoregression module. In FIG. 11C, the illustrated post-processed image data 1131 corresponds to a simulation result for the case where the pre-processed image data 1110 is input without division. On the other hand, in FIG. 11C, the illustrated post-processed image data 1132 corresponds to a simulation result for the case where the incoming pre-processed image data 1110 is divided into two blocks at the divisional line 1111.

Also, in FIG. 11C, a difference image 1133 is an image indicative of a difference between the post-processed image data 1131 and the post-processed image data 1132. As illustrated in the difference image 1133, for the trained model 920 with the autoregression module, no difference arises at the position of the divisional line 1111. In other words, according to the trained model 920 with the autoregression module, the operations can be performed without influence due to a gap arising as a result of dividing the pre-processed image data.

In this manner, according to the trained model 920, even if the pre-processed image data is divided, reduction in simulation accuracy can be avoided.

### <Summary>

As can be appreciated from the above description, a training apparatus according to the first embodiment includes a training model including an encoder unit having multiple convolutional layers and a decoder unit having multiple corresponding deconvolutional layers. The training model further includes an autoregression module. The autoregression module calculates a feature indicative of a dependency of data in a predetermined direction for a data set outputted from a N-th convolutional layer (N is a positive integer) in the encoder unit and inputs the calculated feature to a N-th deconvolutional layer in the decoder unit.

According to the training apparatus of the first embodiment, even if the pre-processed image data is divided into multiple blocks for inputting to the training model, the training model can be trained without arising influence from the division into the multiple blocks.

As a result, according to the training apparatus of the first embodiment, a trained model that can improve simulation accuracy in simulation of semiconductor fabrication processes can be generated.

Also, an inference apparatus according to the first embodiment includes a trained model including an encoder unit having multiple convolutional layers and a decoder unit having multiple corresponding deconvolutional layers. The trained model further includes an autoregression module. The autoregression module calculates a feature indicative of a dependency of data in a predetermined direction for a data set outputted from a N-th convolutional layer (N is a positive integer) in the encoder unit and inputs the calculated feature to a N-th deconvolutional layer in the decoder unit.

According to the inference apparatus of the first embodiment, even if the pre-processed image data is divided into multiple blocks for inputting to the training model, simulation can be achieved without arising influence from the division into the multiple blocks.

As a result, according to the inference apparatus of the first embodiment, simulation accuracy can be improved in simulation of semiconductor fabrication processes.

### Second Embodiment

In the first embodiment, constraint conditions specific to semiconductor fabrication processes for training the training model in the training unit have not been particularly referred to. Meanwhile, some specific constraint conditions are present in the semiconductor fabrication processes and may be reflected to the training at the training unit. In other words, domain knowledge may be reflected to the training at the training unit.

Specifically, some constraints and/or parameter data originating from physical laws (for example, a constraint on preservation of the amount of plasma particles and/or parameter data configured for a chamber such as an electric field) may be imposed to change outputs of the autoregression modules. The reflection of the domain knowledge can further improve the simulation accuracy.

### Third Embodiment

In the first embodiment, calculation of a feature for a data set of one column along the predetermined axial direction 711 has been described. However, the calculation of a feature by the autoregression module is not limited to such a data set of one column along the predetermined axial direction 711. For example, the data set may be extended in a horizontal direction. In other words, similar features may be calculated for other columns. The extension to the horizontal direction can achieve a broad receptive field.

Also, in the first embodiment, the predetermined axial direction 711 is defined based on the divisional direction of the image division unit 121, but the definition of the predetermined axial direction 711 is not limited to it. For example, a data direction having a dependency in a data set outputted from layers in the encoder unit may be defined as the predetermined axial direction 711.

### Other Embodiments

In the first through third embodiments as stated above, the pre-processed image data and the post-processed image data are two-dimensional image data. However, the pre-processed image data and the post-processed image data are not limited to the two-dimensional image data. The pre-processed image data and the post-processed image data may be three-dimensional image data (so-called voxel data).

In the case of the pre-processed image data being two-dimensional image data, the concatenated data may be an array of (channel, vertical size, horizontal size). In the case of the pre-processed image data being three-dimensional image data, the concatenated data may be an array of (channel, vertical size, horizontal size, depth size).

Also, in the first through third embodiments as stated above, the two-dimensional image data is handled as it is. However, the two-dimensional image data or the three-dimensional image data may be transformed and handled. For example, the three-dimensional image data may be obtained, and the two-dimensional image data with respect to a predetermined cross section of the three-dimensional image data may be generated as incoming pre-processed image data. Alternatively, the three-dimensional image data may be generated as the pre-processed image data based on successive pieces of the two-dimensional image data.

Also, channels of the pre-processed image data have not been referred to in the first through third embodiments, but the pre-processed image data may have multiple channels corresponding to types of materials.

Also, in the first through third embodiments, the training apparatus 120 and the inference apparatus 130 have the image division units 121 and 131, respectively. However, the training apparatus 120 and the inference apparatus 130 may not have the image division units 121 and 131, respectively, and the input data generation units 122 and 132 may generate concatenated data based on not-divided pre-processed image data.

Also, in the first through the third embodiments, if the pre-processed image data and the processing related data are input, the inference apparatus 130 outputs the post-processed image data and then terminates its operations. However, the operations of the inference apparatus 130 are not limited to the above. For example, the post-processed image data output in response to the pre-processed image data and the processing related data being input may be inputted to the inference apparatus 130 again together with the corresponding processing related data. In this manner, the inference apparatus 130 can output variations of shapes continuously. Note that the processing related data can be arbitrarily changed when the post-processed image data is input again to the inference apparatus 130.

Also, in the first through the third embodiments, the pre-processed image data, which represents the shape of a to-be-processed wafer before processing at the semiconductor fabrication apparatus 110, and the post-processed image data, which represents the shape of a processed wafer after the processing, are used as training data.

However, the pre-processed image data and the post-processed image data for use as the training data are not limited to the above. For example, the pre-processed image data before simulation by other simulators for the semiconductor fabrication apparatus 110 and the post-processed image data after simulation may be used as the training data. In this manner, the inference apparatus 130 can be used as an alternative of other simulators.

Also, in the first through the third embodiments, a to-be-processed wafer is an object to be processed, but the object is not limited to the to-be-processed wafer. For example, the object may be an inner wall of a chamber, a part surface or the like in the semiconductor fabrication apparatus 110.

Also, in the first through the third embodiments, the measurement apparatus 111 (or the measurement apparatus 112) generates the pre-processed image data (or the post-processed image data). However, the pre-processed image data (or the post-processed image data) may not be necessarily generated by the measurement apparatus 111 (or the measurement apparatus 112). For example, the measurement apparatus 111 (or the measurement apparatus 112) may generate multi-dimensional measurement data indicative of a shape of an object, and the training apparatus 120 may generate the pre-processed image data (or the post-processed image data) based on the measurement data.

Note that the measurement data generated by the measurement apparatus 111 (or the measurement apparatus 112) may include positional information, film type information or the like, for example. Specifically, the measurement data may include a combination of the positional information and CD length measurement data generated by a CD-SEM. Alternatively, the measurement data may include a combination of two or three-dimensional shape information, the film type information or the like generated with X-rays or Raman spectroscopy. In other words, the multi-dimensional measurement data for representing shapes may include various types of representations corresponding to types of measurement apparatuses.

Also, in the first through the third embodiments, the training apparatus 120 and the inference apparatus 130 are illustrated as separate entities, but the training apparatus 120 and the inference apparatus 130 may be arranged as a single entity.

Also, in the first through the third embodiments, the training apparatus 120 is implemented as a single computer but may be arranged with multiple computers. Similarly, the inference apparatus 130 is implemented as a single computer but may be arranged with multiple computers.

Also, in the first through the third embodiments, the training apparatus 120 and the inference apparatus 130 are applied to simulation of semiconductor fabrication processes. However, the training apparatus 120 and the inference apparatus 130 may not be necessarily applied to simulation of semiconductor fabrication processes and may be applied to any other fabrication processes or any type of processes other than fabrication processes.

Also, in the first through the third embodiments, the training apparatus 120 and the inference apparatus 130 are implemented by a generic computer running various programs. However, the implementation of the training apparatus 120 and the inference apparatus 130 is not limited to the above.

For example, the training apparatus 120 and the inference apparatus 130 may be implemented as one or more dedicated electronic circuits (that is, hardware resources) such as an IC (Integrated Circuit) including a processor, a memory and so on. Multiple components may be implemented in a single electronic circuit. Also, a single component may be implemented in multiple electronic circuits. Also, components and electronic circuits may be implemented in a one-to-one manner.

Further, the present disclosure is not limited to these embodiments, but various variations and modifications may be made without departing from the scope of the present disclosure.

Also, all publications, references, patents and patent applications disclosed in the present specification, including “https://arxiv.org/abs/1709.07871” and “https://lmb.informatik.uni-freiburg.de/people/ronneber/u-net/”, are incorporated herein by reference.

The present application is based on and claims priority to Japanese patent application No. 2018-186943 filed on Oct. 1, 2018 with the Japanese Patent Office, the entire contents of which are hereby incorporated by reference.

What is claimed is

1. A training apparatus, comprising:
a memory storing a training model including an encoder unit having multiple convolutional layers and a decoder unit having multiple corresponding deconvolutional layers; and
one or more processors that are configured to:
calculate a feature indicative of a dependency of data in a predetermined direction based on a data set output from a N-th convolutional layer (N is a positive integer) in the encoder unit; and
input the calculated feature to a N-th deconvolutional layer in the decoder unit.

2. The training apparatus as claimed in claim 1, wherein the one or more processors are configured to calculate, in response to a (m+1)-th data set (m is a positive integer) being outputted from the N-th convolutional layer in the encoder unit, a (m+1)-th feature based on a feature calculated based on a m-th data set and the (m+1)-th data set.

3. The training apparatus as claimed in claim 2, wherein the one or more processors are configured to use an autoregression model to calculate the (m+1)-th feature.

4. The training apparatus as claimed in claim 2, wherein the one or more processors are configured to:
divide image data representing a shape of an object in the predetermined direction to generate multiple blocks; and
input the multiple blocks to the encoder unit sequentially.

5. The training apparatus as claimed in claim 4, wherein the one or more processors are configured to arrange processing related data for the object in a predetermined format corresponding to the multiple blocks, concatenate the arranged processing related data with the respective blocks to generate multiple concatenated data, and input the concatenated data to the encoder unit sequentially.

6. The training apparatus as claimed in claim 5, wherein the training model is trained to integrate multiple output results corresponding to the multiple concatenated data output from the decoder unit and approximate the integrated output results to image data indicative of a post-processed shape of the processed object.

7. An inference apparatus, comprising:
a memory storing a trained model including an encoder unit having multiple convolutional layers and a decoder unit having multiple corresponding deconvolutional layers, wherein the trained model is trained with training image data; and
one or more processors that are configured to:
calculate a feature indicative of a dependency of data in a predetermined direction based on a data set output from a N-th convolutional layer (N is a positive integer) in the encoder unit; and
input the calculated feature to a N-th deconvolutional layer in the decoder unit.

8. The inference apparatus as claimed in claim 7, wherein the one or more processors are configured to calculate, in response to a (m+1)-th data set (m is a positive integer) being output from the N-th convolutional layer in the encoder unit, a (m+1)-th feature based on a feature calculated based on a m-th data set and the (m+1)-th data set.

9. The inference apparatus as claimed in claim 8, wherein the one or more processors are configured to use an autoregression model to calculate the (m+1)-th feature.

10. The inference apparatus as claimed in claim 8, wherein the one or more processors are configured to:
divide image data representing a shape of an object in the predetermined direction to generate multiple blocks; and
input the multiple blocks to the encoder unit sequentially.

11. The inference apparatus as claimed in claim 10, wherein the one or more processors are configured to arrange processing related data for the object in a predetermined format corresponding to the multiple blocks, concatenate the arranged processing related data to the respective blocks to generate multiple concatenated data, and input the concatenated data to the encoder unit sequentially.

12. The inference apparatus as claimed in claim 11, wherein the one or more processors are configured to integrate multiple output results corresponding to the multiple concatenated data output from the decoder unit and output the integrated output results as a simulation result.

13. A computer-readable storage medium for storing a trained model trained by a computer with use of training image data, wherein the trained model includes an encoder unit having multiple convolutional layers and a decoder unit having multiple corresponding deconvolutional layers, and the computer is configured to:
calculate a feature indicative of a dependency of data in a predetermined direction based on a data set output from a N-th convolutional layer (N is a positive integer) in the encoder unit; and
input the calculated feature to a N-th deconvolutional layer in the decoder unit.
